(19) United States
(12) Patent Application Publication
(10) Pub. No.: US 2024/0049623 A1
(43) Pub. Date: Feb. 15, 2024

(54) MIX CALCULATOR

(71) Applicant: Precision Planting LLC, Tremont, IL (US)

(72) Inventors: Myra Renee Cooper, Trivoli, IL (US); Brendan O'Rourke, Pekin, IL (US); David Aaron WILCOXSON, Tremont, IL (US); Ryan Allgaier, East Peoria, IL (US)

(21) Appl. No.: 18/260,639

(22) PCT Filed: Jan. 28, 2022
(86) PCT No.: PCT/IB2022/050762

§ 371 Date: Jul. 7, 2023

Related U.S. Application Data
(60) Provisional application No. 63/154,222, filed on Feb. 26, 2021.
(60) Provisional application No. 63/150,441, filed on Feb. 17, 2021.

(51) Int. Cl. A01C 21/00

(52) U.S. Cl. CPC A01C 21/00

(57) ABSTRACT

A method for determining amounts of material to add to a mixture of agricultural materials to be applied to a field based on an area of a field yet to be applied or how much material can be added to a storage tank.

### CROSS REFERENCE TO RELATED APPLICATIONS

This application claims priority to U.S. Provisional Application Nos. 63/150,441, filed 17 Feb. 2021 and 63/154,222, filed 26 Feb. 2021, the contents of each are incorporated herein by reference in their entireties.

### BACKGROUND

In many agricultural applications, materials that are applied to agricultural fields are mixtures of materials. The materials can be either fluids or solids. When starting with an empty tank, determining the amount of materials to form the mixture is based on a formula for the size of the tank.

### BRIEF DESCRIPTION OF THE DRAWINGS

FIG. 1 illustrates an agricultural field with an agricultural implement applying an agricultural material mixture to the field.

FIG. 2 illustrates a process for determining amount of refill materials.

FIG. 3 illustrates a system.

FIG. 4 illustrates a control screen for controlling a material application.

FIG. 5 illustrates a mix screen.

FIG. 6 illustrates mix input screen for inputting a material.

FIG. 7 illustrates a subsequent mix input screen for selecting rate units for the material selected in FIG. 6.

FIG. 8 illustrates a subsequent mix input screen for inputting the amount of material selected in FIG. 7.

FIG. 9 illustrates a mix input screen with all materials listed.

FIG. 10 illustrates the mix screen from FIG. 5 with the mix listed.

FIG. 11 illustrates the mix screen showing actual amounts of inputs to create the mix.

FIG. 12 illustrates the mix screen with the mix, the size of the field, and the rate to apply.

FIG. 13 illustrates amounts of each input applied at a first time.

FIG. 14 illustrates amounts of each input applied at a later time.

### DETAILED DESCRIPTION

All references cited herein are incorporated herein in their entireties. If there is a conflict between a definition herein and in an incorporated reference, the definition herein shall control.

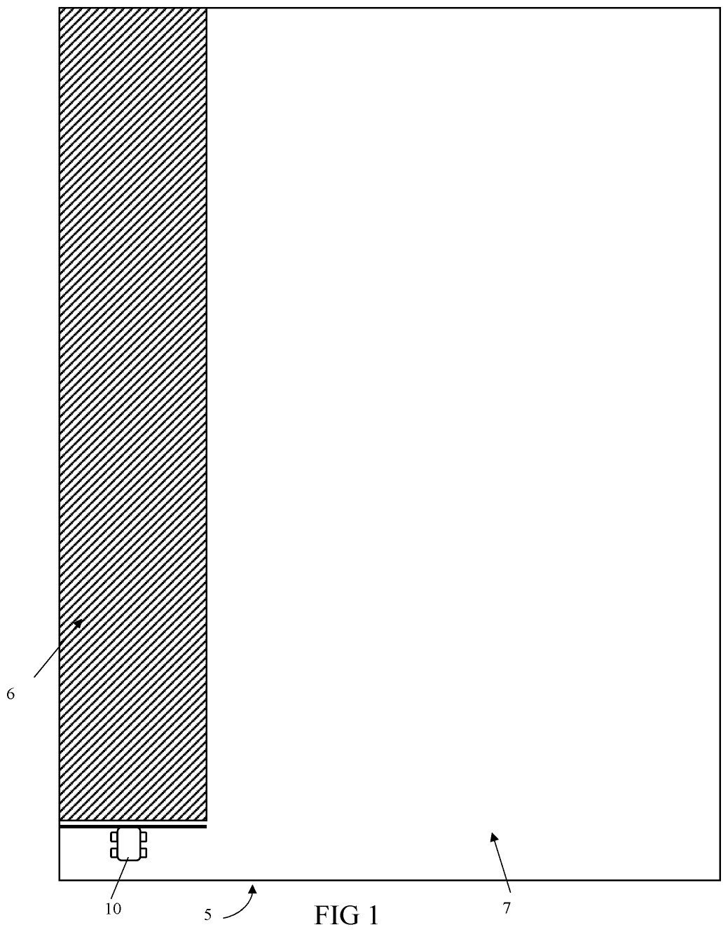

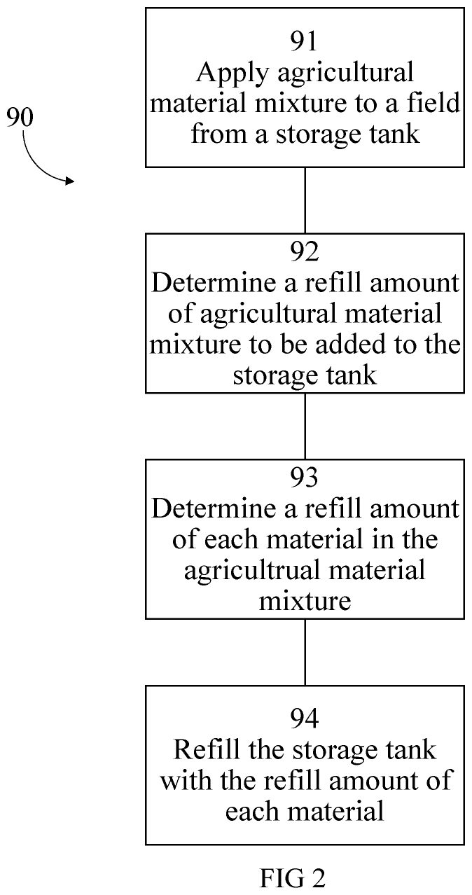

Referring to the drawings, wherein like reference numerals designate identical or corresponding parts throughout the several views, FIG. 1 illustrates an agricultural field 5 with an agricultural implement 10 applying an agricultural material mixture to agricultural field 5 in which an applied area 6 has had the agricultural material mixture applied, and there is an unapplied area 7. Agricultural implement 10 can be any agricultural implement. Examples include, but are not limited to sprayers, spreaders, planters, air seeders, and sidedress bars. The agricultural material mixture can be a fluid or a solid. An amount of agricultural material mixture can be mass or volume.

An initial amount of agricultural material mixture is added to a storage tank on an agricultural implement. The agricultural material mixture is a mixture of individual materials. This varies based on the material. There is a formula for an amount of each material in a given amount of the agricultural material mixture. Based on the amount of the agricultural material mixture, the amount of each material is calculated from the formula.

As the agricultural implement 10 is drawn across field 5, the agricultural material mixture is applied to field 5. An amount of agricultural material mixture that is applied can be determined by measuring amounts applied through flowmeters, or the amount is calculated by multiplying the application rate by the amount of time for application. An amount of agricultural material mixture remaining in the storage tank can be calculated by subtracting the applied amount from the initial amount.

A refill amount of agricultural material mixture is determined to be added to the storage tank. The refill amount can be determined by determining an amount needed to be applied to the unapplied area and subtracting the remaining amount of agricultural material mixture in the storage tank. The refill amount can be determined by an amount of agricultural material mixture that can be added to the storage tank based on the remaining amount of agricultural material mixture in the storage tank. Once the refill amount is known, the formula for the agricultural material mixture is used to determine an amount of each material for the agricultural material mixture. The storage tank is then refilled with the amount of each material.

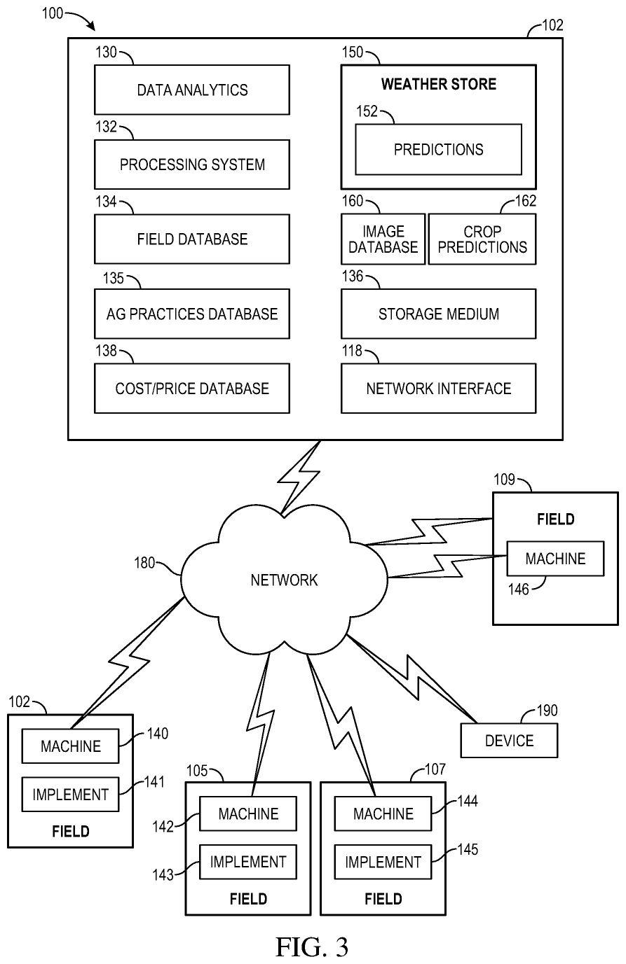

FIG. 3 shows an example of a system 100 for performing agricultural operations (e.g., applying fluid applications to plants) of agricultural fields including operations of an implement having application units. For example, the system 100 may be implemented as a cloud based system with servers, data processing devices, computers, etc. Aspects, features, and functionality of the system 100 can be implemented in servers, planters, planter monitors, sprayers, sidedress bars, combines, laptops, tablets, computer terminals, client devices, user devices (e.g., device 190), handheld computers, personal digital assistants, cellular telephones, cameras, smart phones, mobile phones, computing devices, or a combination of any of these or other data processing devices.

The system 100 can include a network computer or an embedded processing device within another device (e.g., display device) or within a machine (e.g., planter, combine), or other types of data processing systems having fewer components or perhaps more components than that shown in FIG. 1. The system 100 (e.g., cloud based system) and agricultural operations can control and monitor fluid applications using an implement or machine. The system 100 includes machines 140, 142, 144, 146 and implements 141, 143, 145 coupled to a respective machine 140, 142, 144, 146. The implements (or machines) can include flow devices for controlling and monitoring applications (e.g., seeding, spraying, fertilization) of crops and soil within associated fields (e.g., fields 102, 105, 107, 109). The system 100 includes an agricultural analysis system 102 that can include a weather store 150 with current and historical weather data, weather predictions module 152 with weather predictions for different regions, and at least one processing system 132 for executing instructions for controlling and monitoring different operations (e.g., fluid applications). The storage medium 136 may store instructions, software, software programs, etc. for execution by the processing system and for performing operations of the agricultural analysis system 102. In one example, storage medium 136 may contain a fluid application prescription (e.g., fluid application prescription that relates georeferenced positions in the field to application rates). The implement 141 (or any of the implements) may include an implement 200 whose pump, flow sensors and/or flow controllers may be specifically the elements that are in communication with the network 180 for sending control signals or receiving as-applied data.

Examples of agricultural monitors are described in PCT Publication Nos. WO2008/086318, WO2012/129442, WO2013/049198, WO2014/026183, and WO2014/018717. An example of an agricultural monitor is the 20120® monitor from Precision Planting, LLC.

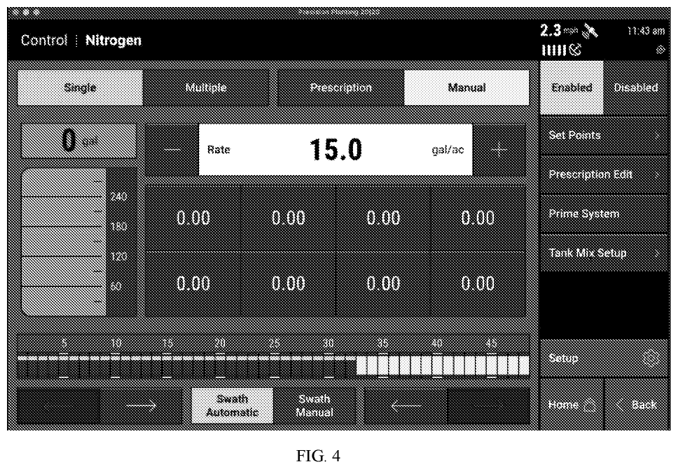

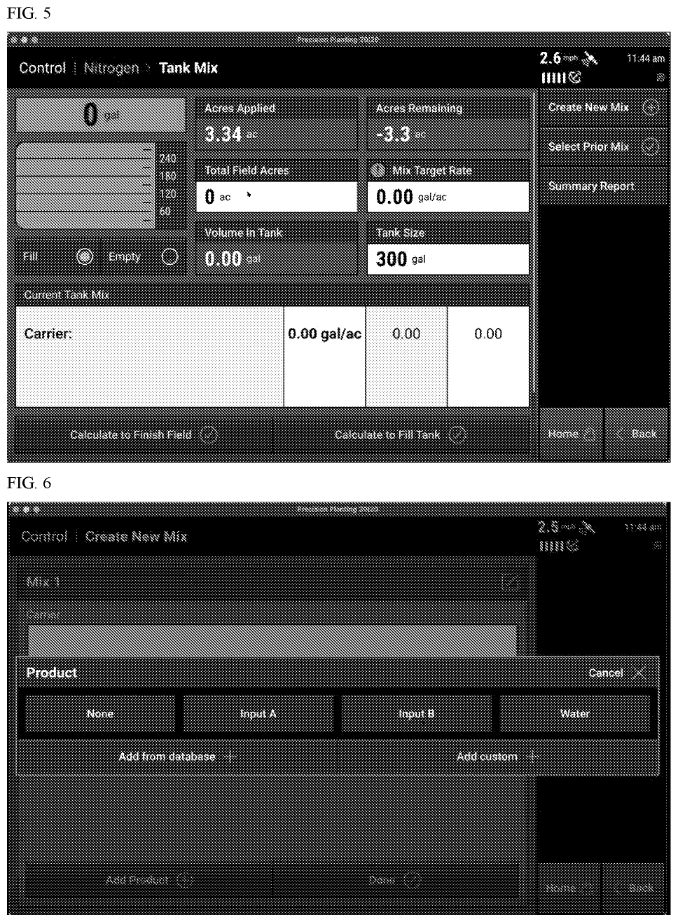

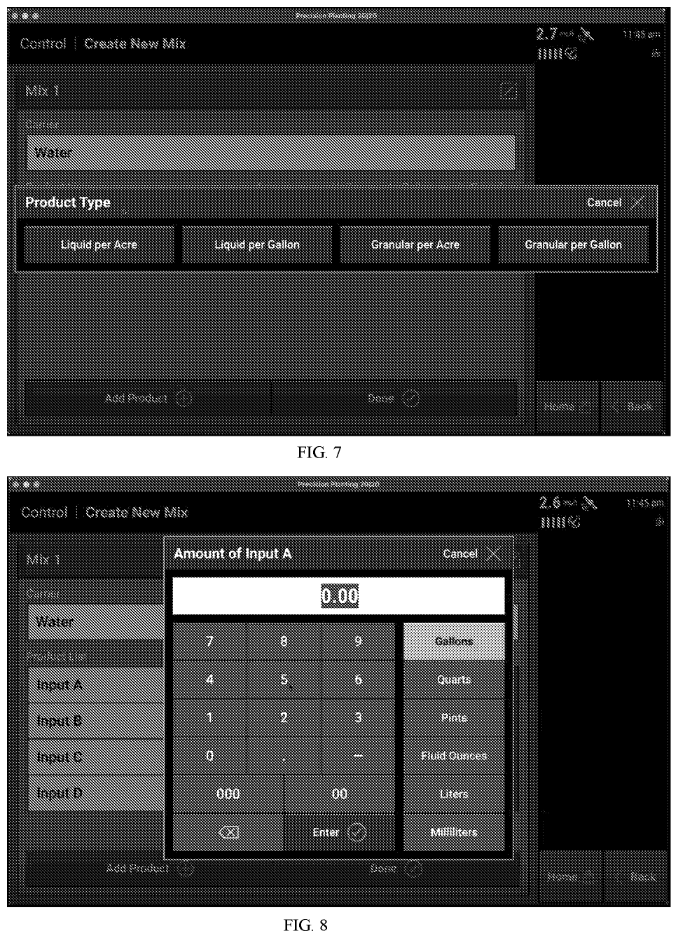

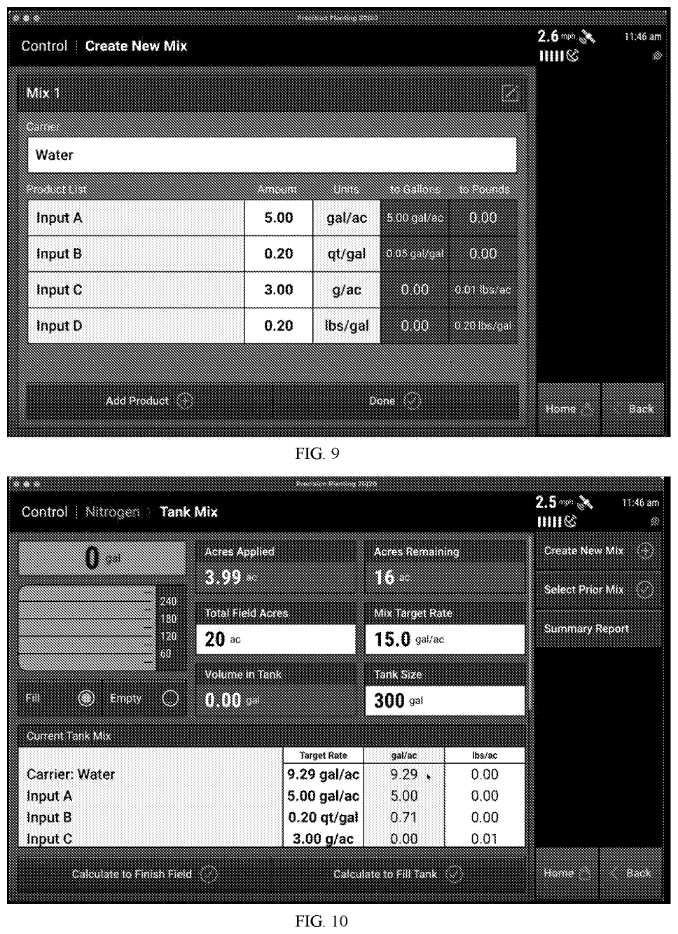

FIGS. 4-14 illustrate several screens on a monitor for creating and applying a mixture to a field. In FIG. 4, a control screen for controlling a material application (e.g., Nitrogen application) includes a rate (e.g., 15 gal/ac) and a tank mix setup button. Upon selection of the tank mix setup button, a mix screen of FIG. 5 is generated. In FIG. 5, a mix screen can have the following: Tank Size, Total Field Acres (the area to be applied), Mix Target Rate (the amount of mix to apply per area), Volume in Tank along with an optional Tank Level Gauge, and the Current Tank Mix (the formula for the mixture), a Create New Mix button, a Select Prior Mix button, a Summary Report Button, Acres Applied, and Acres Remaining. FIG. 6 illustrates a Create New Mix screen after the Create New Mix button is selected from FIG. 5. There is an Add Product Button, and FIG. 6 illustrates the pop-up Product Screen on FIG. 6. There are buttons for Add Custom, or optionally, Add from database. A list of Inputs are provided. For the first input, water is selected. Next in FIG. 7, the rate units for the input are selected. Examples of rate inputs include, but are not limited to, liquid per acre, liquid per gallon, granular per acre, or granular per gallon. Next in FIG. 8, the amount of the input is entered along with its units of measurement. Since water was selected, and chosen as gallons per acre, the units are different volume units. FIG. 9 illustrates a completed mix showing the rate units and amount selected, and optionally converted to a standard volume (such as gallons) or mass (pounds) for all inputs.

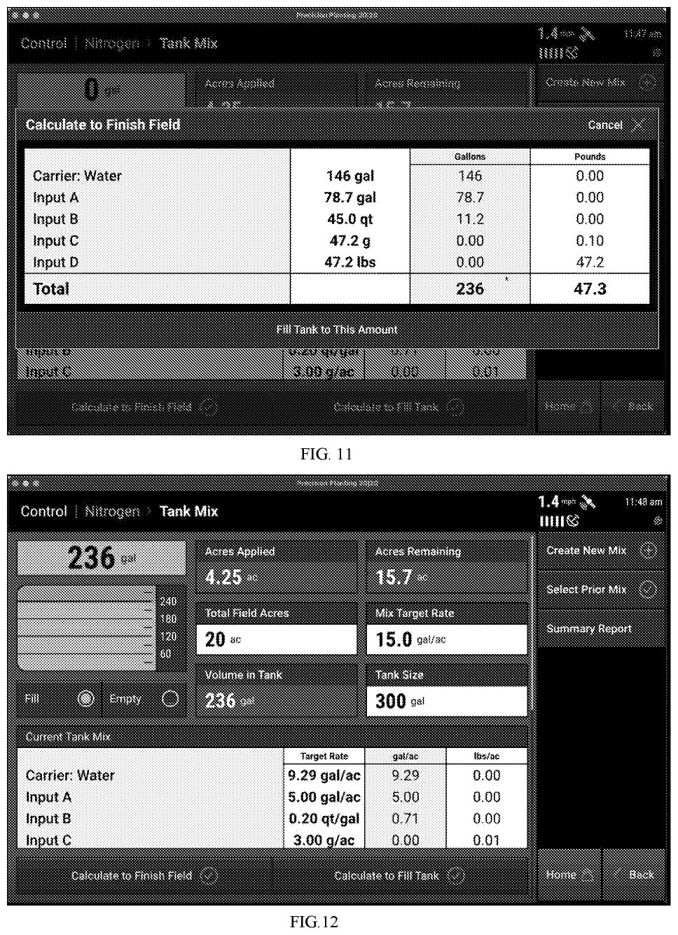

FIG. 10 illustrates the mix screen with the mix input along with the acres to apply and the mix target rate. Depending on the acres to apply and the rate to apply the mixture, the amount of mixture is calculated by selecting the Calculate to Fill Tank button (initially). There is also a Calculate to Finish Field button, which can provide an amount as described above to finish a field after a portion has been applied. FIG. 11 illustrates a pop-up window to provide the actual amounts of inputs to add to the mix tank. FIG. 12 illustrates the mix screen after all selections are made and some area has been applied.

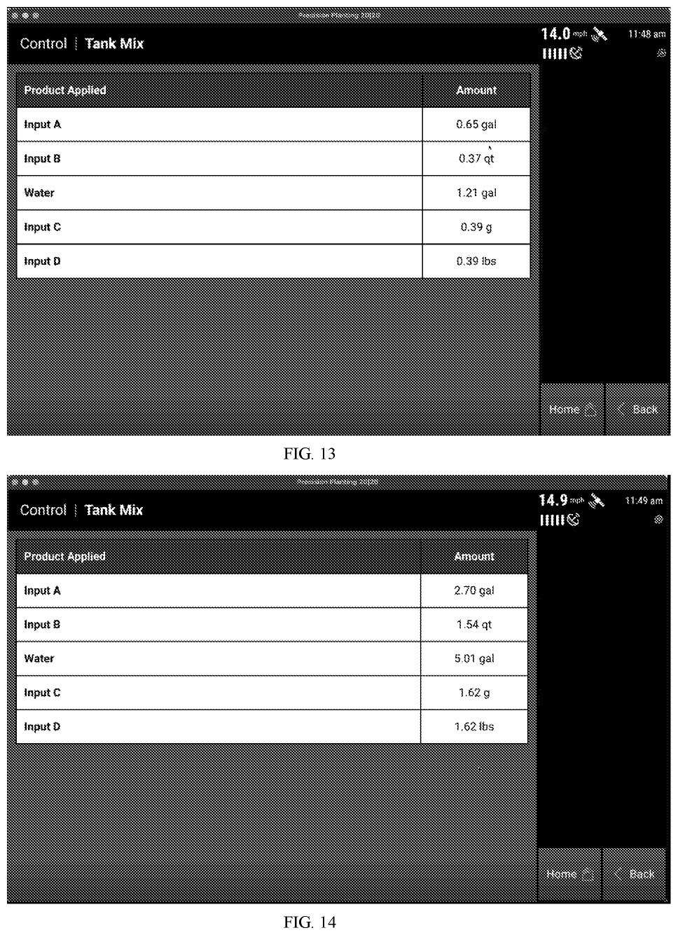

By tracking the amount of mixture applied to the acres applied, the amounts of each input can be displayed on a Product Applied screen. The amounts of inputs applied at a first time are illustrated in FIG. 13 and at a second time in FIG. 14.

The above illustrates creating a first mixture and adding it to the tank. Multiple mixtures can be separately added to the tank. The inputs from each mixture can also be tracked separately in the Product Applied screen such as in FIGS. 13 and 14.

### EXAMPLES

The following are nonlimiting examples.

Example 1—A method comprising: applying an agricultural material mixture from an agricultural implement as the agricultural implement is driven across a field, wherein the agricultural implement includes a storage tank for storing an initial amount of the agricultural material mixture, wherein there is an initial amount of agricultural material mixture in the storage tank, and wherein the field has an applied area and an unapplied area; determining a refill amount of agricultural material mixture to be added to the storage tank; determining a refill amount of each material in the agricultural material mixture from a formula for the agricultural mixture and the refill amount of agricultural material mixture; refilling the storage tank with the refill amount of each material in the agricultural material mixture; wherein the refill amount of the agricultural material mixture is determined by one of: an amount of material to be applied to the unapplied area; or an amount of material that can be added to the tank.

Example 2—the method of Example 1 further comprising determining an amount of material application to the field.

Example 3—the method of Example 2, wherein the determining the amount of material application is measured by flow meters.

Example 4—the method of Example 2 or 3, wherein the determining the amount of material application is calculated by multiplying a time of applying by a flow rate of application.

Example 5—the method of any preceding Example, wherein the refill amount of agricultural material mixture is determined by the amount of material to be applied to the unapplied area and is obtained by subtracting a remaining amount of agricultural material mixture in the storage tank from the amount of material to be applied to the unapplied area.

Example 6—the method of any of Examples 1 to 4, wherein the amount of material that can be added to the tank is obtained by subtracting the amount of material application to the field from the initial amount of agricultural material mixture.

The foregoing description is presented to enable one of ordinary skill in the art to make and use the invention and is provided in the context of a patent application and its requirements. Various modifications to the preferred embodiment of the apparatus, and the general principles and features of the system and methods described herein will be readily apparent to those of skill in the art. Thus, the present invention is not to be limited to the embodiments of the apparatus, system and methods described above and illustrated in the drawing figures but is to be accorded the widest scope consistent with the spirit and scope of the appended claims.

1. A method comprising:
applying an agricultural material mixture from an agricultural implement as the agricultural implement is driven across a field, wherein the agricultural implement includes a storage tank for storing an initial amount of the agricultural material mixture, wherein there is an initial amount of agricultural material mixture in the storage tank, and wherein the field has an applied area and an unapplied area;
determining a refill amount of agricultural material mixture to be added to the storage tank;
determining a refill amount of each material in the agricultural material mixture from a formula for the agricultural mixture and the refill amount of agricultural material mixture;
refilling the storage tank with the refill amount of each material in the agricultural material mixture;
wherein the refill amount of the agricultural material mixture is determined by one of:
an amount of material to be applied to the unapplied area; or
an amount of material that can be added to the tank.

2. The method of claim 1 further comprising determining an amount of material application to the field.

3. The method of claim 2, wherein the determining the amount of material application is measured by flow meters.

4. The method of claim 2 or 3, wherein the determining the amount of material application is calculated by multiplying a time of applying by a flow rate of application.

5. The method of claim 1, wherein the refill amount of agricultural material mixture is determined by the amount of material to be applied to the unapplied area and is obtained by subtracting a remaining amount of agricultural material mixture in the storage tank from the amount of material to be applied to the unapplied area.

6. The method of claim 1, wherein the amount of material that can be added to the tank is obtained by subtracting the amount of material application to the field from the initial amount of agricultural material mixture.
